(19) United States
(12) Patent Application Publication
(10) Pub. No.: US 2026/0153106 A1
(43) Pub. Date: Jun. 4, 2026

(54) HOLDING CLIP ASSEMBLY

(71) Applicant: ILLINOIS TOOL WORKS INC., Glenview, IL (US)

(72) Inventors: Zheng LUO, Shanghai (CN); Zhilin LI, Shanghai (CN); Haijie YU, Shanghai (CN)

(21) Appl. No.: 19/401,626

(22) Filed: Nov. 26, 2025

(30) Foreign Application Priority Data
Nov. 29, 2024 (CN) 2024117449596
Nov. 21, 2025 (CN) 2025224720864

(51) Int. Cl. F16B 2/20; F16J 15/3204; F16J 15/3268

(52) U.S. Cl. CPC F16B 2/20; F16J 15/3204; F16J 15/3268

(57) ABSTRACT

The present disclosure provides a holding clip assembly including a holding clip including a first clip portion and a second clip portion connected to each other, the first clip portion having a first receiving channel, and the second clip portion having a second receiving channel; and a sealing member including a first sealing portion and a second sealing portion connected to each other, the first sealing portion being received in the first receiving channel and having a third receiving channel, and the second sealing portion being arranged on a top of the first clip portion away from the second clip portion. The first clip portion and the second clip portion are configured to hold at least a part of the second component therebetween. The first clip portion is configured to be connected at the top to the first component. The third receiving channel and the second receiving channel are configured to receive the fastener. The first clip portion is provided with a limiting structure, the first sealing portion is provided with a limited structure, and the limiting structure cooperate with the limited structure to limit a movement of the sealing member relative to the first clip portion.

### CROSS-REFERENCE TO RELATED APPLICATIONS

The present disclosure claims priority to Chinese Patent Application No. 202411744959.6, filed on Nov. 29, 2024, entitled “Nut Assembly”, the entire contents of which are incorporated herein by reference.

### TECHNICAL FIELD

The present disclosure relates to a holding clip assembly, and particularly, to a holding clip assembly for sealing.

### BACKGROUND

The holding clip assembly usually cooperates with a fastener to connect one component to another. The holding clip assembly and the fastener together are used to clamp one component, and the holding clip assembly is used to hold/clamp the other component. In one application, it is desirable to prevent contaminants outside the one component, such as water and dust, etc., from entering the other component to damage the other component or components inside the other component. For example, the one component may be a vehicle sheet metal, and the other component may be a vehicle interior trim part. It is often desirable to block contaminants outside the vehicle, such as outside the vehicle sheet metal, to avoid damaging the vehicle interior trim part or components inside the vehicle.

### SUMMARY OF THE DISCLOSURE

The present disclosure relates generally to a holding clip assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A shows a perspective view of a holding clip assembly according to an embodiment of the present disclosure.

FIG. 1B shows an exploded view of FIG. 1A.

FIG. 1C shows a left view of FIG. 1A.

FIG. 1D shows a cross-sectional view along section line A-A in FIG. 1C.

FIG. 2A shows an assembled perspective view of a holding clip assembly cooperating with a fastener to connect a first component to a second component according to an embodiment of the present disclosure.

FIG. 2B shows a right view of FIG. 2A.

FIG. 2C shows a cross-sectional view along section line B-B in FIG. 2A.

FIG. 2D shows an exploded view of FIG. 2A.

FIG. 3A shows a perspective view of a holding clip assembly according to another embodiment of the present disclosure.

FIG. 3B shows an exploded view of FIG. 3A.

FIG. 3C shows a front view of the holding clip of FIG. 3A.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Through long-term observation and research, it has been discovered that a holding clip assembly is provided with a sealing member to prevent contaminants outside one component from entering the other component. The holding clip assembly includes a holding clip and a sealing member. The sealing member includes a sleeve portion and a flange portion. The holding clip and the sealing member are made of plastic. The sleeve portion is formed on the holding clip by molding. As for the holding clip made of a rigid material (such as metal), it is difficult to mold the sleeve portion made of plastic onto the holding clip.

In order to at least partly solve the above problems, according to a first aspect of the present disclosure, the present disclosure provides a holding clip assembly for connecting a first component to a second component in cooperation with a fastener. The holding clip assembly includes a holding clip and a sealing member. The holding clip includes a first clip portion and a second clip portion connected to each other, the first clip portion has a first receiving channel, and the second clip portion has a second receiving channel. The sealing member includes a first sealing portion and a second sealing portion connected to each other, the first sealing portion is received in the first receiving channel and has a third receiving channel, and the second sealing portion is arranged on a top of the first clip portion away from the second clip portion. The first clip portion and the second clip portion are configured to hold at least a part of the second component between the first clip portion and the second clip portion. The first clip portion is configured to be connected at the top to the first component. The third receiving channel and the second receiving channel are configured to receive the fastener. The first clip portion is provided with a limiting structure, the first sealing portion is provided with a limited structure, and the limiting structure cooperate with the limited structure to limit the movement of the sealing member relative to the first clip portion.

In some embodiments, the first clip portion includes a first planar portion and a first collar. The first planar portion includes first and second sides opposite each other, and the top of the first clip portion is formed on the first side. The first collar is connected to the second side of the first planar portion and forms the first receiving channel together with the first planar portion. The limiting structure is provided on the first collar.

In some embodiments, the limiting structure includes an opening provided on the first collar, and the limited structure includes a protrusion provided on the first sealing portion, the protrusion is received by the opening.

In some embodiments, the opening opens toward the second clip portion.

In some embodiments, the limiting structure includes two openings arranged symmetrically with respect to a central axis of the first collar. The limited structure includes two protrusions arranged symmetrically with respect to a central axis of the third receiving channel.

In some embodiments, the first sealing portion is sleeve-shaped, and the second sealing portion is flange-shaped.

In some embodiments, the second sealing portion is provided with at least one annular protrusion on a side away from the top of the first clip portion.

In some embodiments, the second sealing portion is provided with at least two annular protrusions radially spaced apart.

In some embodiments, the first clip portion is provided with a protruding abutting portion on the top, the abutting portion is disposed around the second sealing portion and is configured to abut against the first component.

In some embodiments, the abutting portion is arranged spaced apart from the second sealing portion.

In some embodiments, the second clip portion includes a second planar portion and a second collar. The second collar is connected to a side of the second planar portion away from the first clip portion and forms the second receiving channel together with the second planar portion. The second planar portion is spaced apart from the first planar portion of the first clip portion so as to receive the at least part of the second component therebetween. The second receiving channel has an internal thread that engages with the fastener.

In some embodiments, the first planar portion is connected to the second planar portion via an elastic connecting portion to form a generally U-shaped holding clip.

In some embodiments, an axial length of the first collar is set such that when the first component and the second component are connected to the holding clip assembly in position, a free end of the first collar abuts against the second clip portion.

In some embodiments, the axial length of the first collar is set such that when the first component and second component are connected to the holding clip assembly in position, a free end of the first collar is spaced apart from the second clip portion.

In some embodiments, the holding clip is formed of a metal material, and the sealing member is formed of thermoplastic elastomer or rubber.

In the present disclosure, the limiting structure is provided on the first clip portion of the holding clip and the limited structure is provided on the first sealing portion of the sealing member, and the limiting structure cooperates with the limited structure to limit the movement of the sealing member relative to the first clip portion, thereby limiting the movement of the sealing member relative to the holding clip. This enables the sealing member to be easily retained in the holding clip to provide stable sealing, without being limited by the materials of the both, and without affecting the original function of the holding clip assembly.

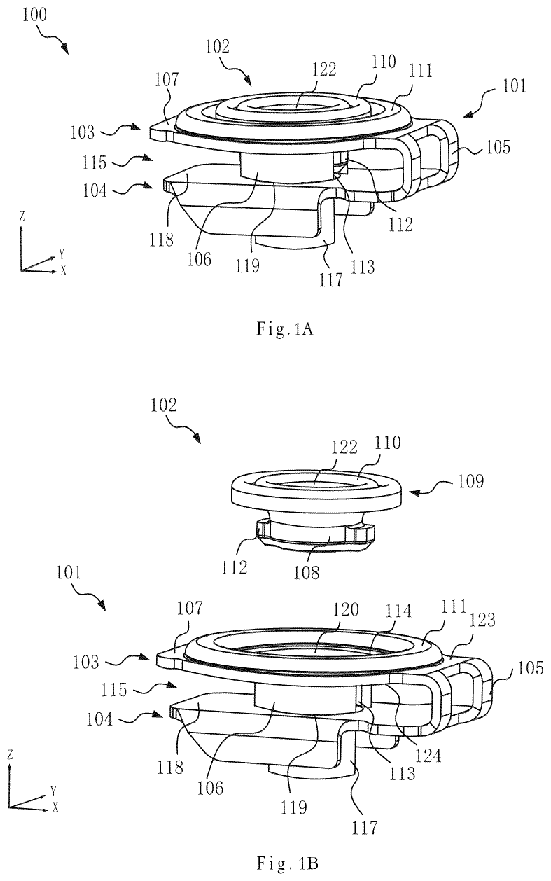

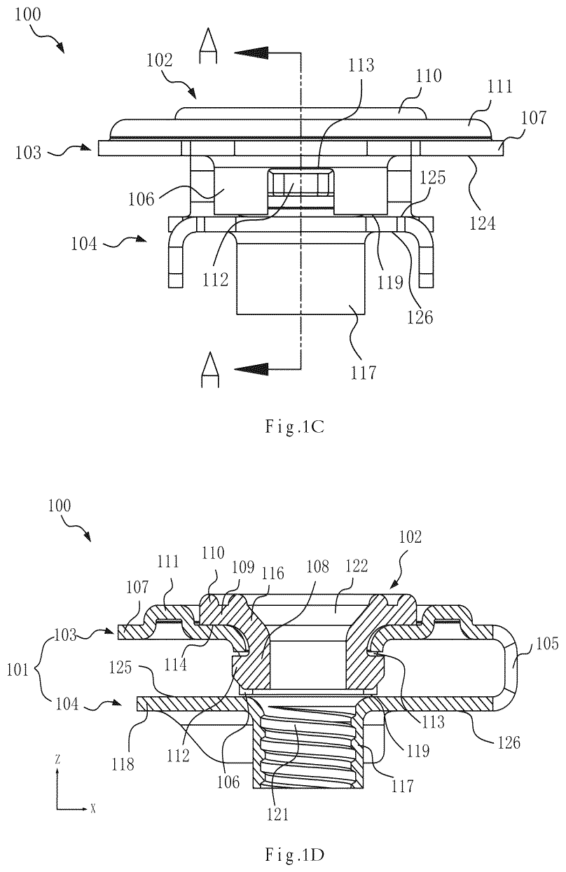

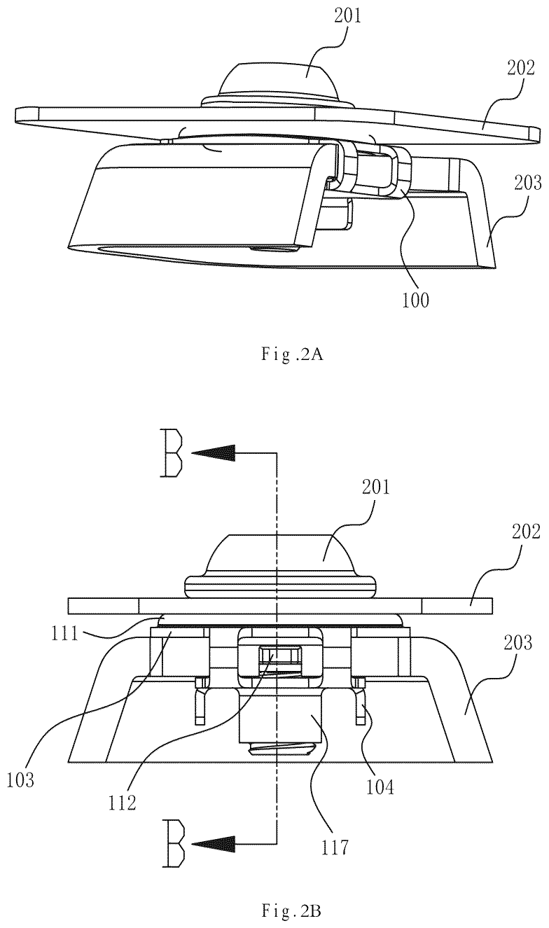

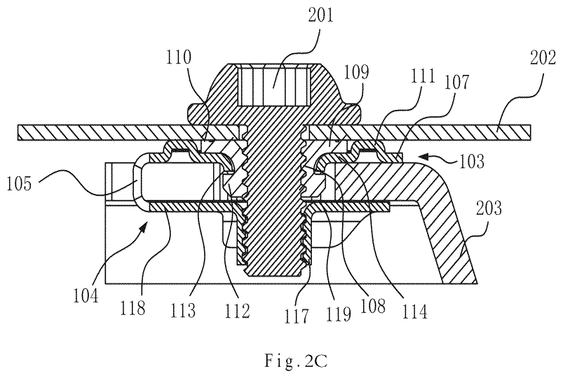

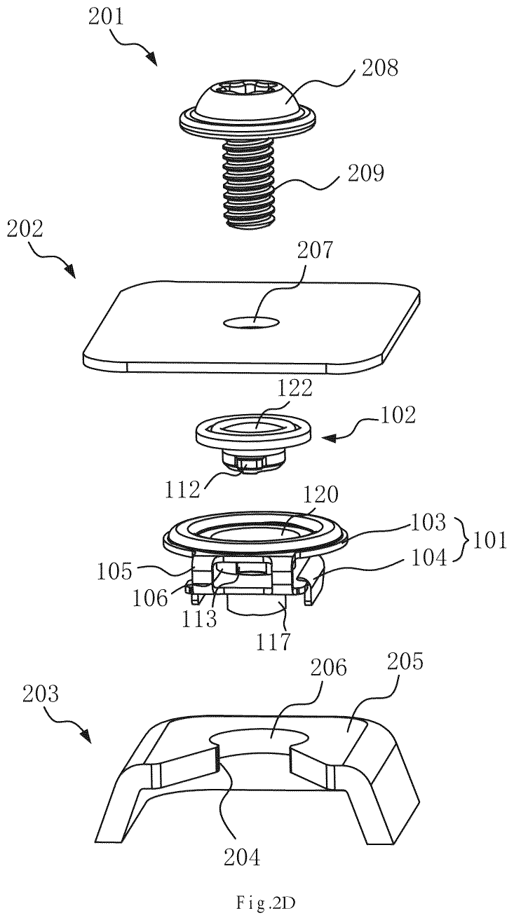

FIG. 1A shows a perspective view of a holding clip assembly 100 according to an embodiment of the present disclosure, FIG. 1B shows an exploded view of FIG. 1A, FIG. 1C shows a left view of FIG. 1A, and FIG. 1D shows a cross-sectional view along section line A-A in FIG. 1C. The holding clip assembly 100 is configured to cooperate with a fastener 201 to connect a first component 202 to the second component 203 (see FIGS. 2A-2D).

As shown in FIGS. 1A-1D, the holding clip assembly 100 includes a holding clip 101 and a sealing member 102. The holding clip 101 includes a first clip portion 103 and a second clip portion 104 connected to each other. The first clip portion 103 has a first receiving channel 120, and the second clip portion 104 has a second receiving channel 121. The sealing member 102 includes a first sealing portion 108 and a second sealing portion 109 connected to each other. The first sealing portion 108 is received in the first receiving channel 120 and has a third receiving channel 122. The second sealing portion 109 is arranged on the top of the first clip portion 103 away from the second clip portion 104. As shown in FIG. 1A, the holding clip assembly 100 has a length direction consistent with an X-axis direction, a width direction consistent with a Y-axis direction, and a height direction consistent with a Z-axis direction. The first receiving channel 120, the second receiving channel 121 and the third receiving channel 122 are arranged in the height direction. The first clip portion 103 and the second clip portion 104 are configured to hold at least a part of the second component 203 between the first clip portion 103 and the second clip portion 104, the first clip portion 103 is configured to be connected at its top to the first component 202, and the third receiving channel 122 and the second receiving channel 121 are configured to receive the fastener 201 (see FIG. 2C).

The first clip portion 103 is provided with a limiting structure 113, and the first sealing portion 108 is provided with a limited structure 112. The limiting structure 113 cooperates with the limited structure 112 to limit the movement of the sealing member 102 relative to the first clip portion 103. This allows the sealing member 102 to remain in place in the holding clip 101 without being disengaged from the holding clip 101 due to inversion (in the direction shown), transport, external forces (such as an upward pull-out force exerted by the fastener 201), etc. And, when the holding clip assembly 100 is connected by the fastener 201 to the first component 202 and the second component 203, the movement of the fastener 201 does not drive the sealing member 102 to move relative to the first clip portion 103, such that the sealing member 102 can provide a stable sealing effect (see FIGS. 2C-2D).

The first clip portion 103 of the holding clip 101 includes a first planar portion 107 and a first collar 106. The first planar portion 107 includes first and second sides 123, 124 opposite to each other. The top of the first clip portion 103 is formed on the first side 123. The first collar 106 is connected to the second side 124 of the first planar portion 107 and forms the first receiving channel 120 together with the first planar portion 107. The first planar portion 107 includes a central opening that is located substantially in the center of the first planar portion 107 and is connected to a side of the first collar 106 close to the first planar portion 107. The first sealing portion 108 is inserted into the first collar 106 through the central opening of the first planar portion 107.

The limiting structure 113 is disposed on the first collar 106. The limiting structure 113 includes an opening provided on the first collar 106, the limited structure 112 includes a protrusion provided on the first sealing portion 108, and the protrusion is received by the opening. The opening opens toward the second clip portion 104. The opening is generally concave in shape. The protrusion projects radially outwardly from an outer surface of the first sealing portion 108. The opening is engaged with the protrusion to limit the movement of the sealing member 102 relative to the first clip portion 103 in a direction away from the second clip portion 104 to be disengaged from the retaining clip 101, and to limit the circumferential movement of the sealing member 102 relative to the first clip portion 103, such that the fastener 201 (see FIG. 2C) is prevented from driving the sealing member 102 to move when connected to the second clip portion 104 by movement (e.g., rotation), thus providing stable sealing. As shown in FIGS. 1B and 1D, the limiting structure 113 includes two openings disposed on the first collar 106, and the two openings are symmetrically disposed with respect to a central axis of the first collar 106. The limited structure 112 includes two protrusions which are symmetrically disposed with respect to a central axis of the third receiving channel 122 of the first sealing portion 108. In other embodiments, the limiting structure 113 and the limited structure 112 include other suitable structures to implement the above function.

The second sealing portion 109 is provided with at least one annular protrusion 110 on its side away from the top of the first clip portion 103. The at least one annular protrusion 110 is configured to deform such that the second sealing portion 109 provides sealing between the first clip portion 103 and the first component 202. As shown in FIGS. 1B and 1D, the second sealing portion 109 is provided with at least two annular protrusions 110 radially spaced apart. The at least two annular protrusions 110 have a deformable space, that is, at least being deformable radially. As shown in FIG. 1D, the sealing member 102 further includes a guiding portion 116 that connects the first sealing portion 108 and the second sealing portion 109. The guiding portion 116 is configured to guide the fastener 201 (see FIGS. 2A-2D) into the sealing member 102. The first sealing portion 108 is sleeve-shaped, and the second sealing portion 109 is flange-shaped. The guiding portion 116 is generally conical. One end of the guiding portion 116 having a larger opening is connected to an inner side of the second sealing portion 109, and the other end of the guiding portion 116 having a smaller opening is connected to the top of the first sealing portion 108. The guiding portion 116 provides a deformable space for the annular protrusion 110 adjacent thereto. In a preferred embodiment, the sealing member 102is formed of thermoplastic elastomer (TPE). In another embodiment, the sealing member 102 is formed of rubber. The sealing member may also be formed of other suitable materials to achieve the above sealing. The sealing member 102 can be integrally formed.

The first clip portion 103 is provided with a protruding abutting portion 111 on its top, and the abutting portion 111 is disposed around the second sealing portion 109 and is configured to abut against the first component 202 (see FIG. 2C). The abutting portion 111 can provide a hard connection between the first clip portion 103 and the first component 202, thereby ensuring that the fastener 201 and the holding clip assembly 100 fasten the first component 202, preventing the first component 202 from loosening. The second sealing portion 109 is higher than the abutting portion 111 in the height direction, thereby ensuring that the second sealing portion 109 provides sealing between the first clip portion 103 and the first component 202. For example, the annular protrusion 110 of the second sealing portion 109 is higher than the abutting portion 111 in the height direction. The abutting portion 111 is arranged spaced apart from the second sealing portion 109, so as to provide a deformable space for the second sealing portion 109. The second sealing portion 109 is arranged on a support portion 114 of the top of the first planar portion 107 close to the central opening of the first planar portion 107. In contrast to the second sealing portion 109, the abutting portion 111 is arranged away from the central opening and radially spaced apart from the second sealing portion 109. The second sealing portion 109 can deform at least radially toward the abutting portion 111. The holding clip 101 is formed of a metal material.

The second clip portion 104 includes a second planar portion 118 and a second collar 117. The second planar portion 118 includes first and second sides 125, 126 opposite to each other. The first side 125 faces the first clip portion 103, and the second side 126 is away from the first clip portion 103. The second collar 117 is connected to the second side 126 and forms a second receiving channel 121 together with the second planar portion 118. The second planar portion 118 is spaced apart from the first planar portion 107 of the first clip portion 103 so as to receive the at least part of the second component 203 therebetween (see FIG. 2C). The first planar portion 107 is connected to the second planar portion 118 via an elastic connecting portion 105 to form a generally U-shaped holding clip 101. The second planar portion 118 is spaced apart from the first planar portion 107 to form a fourth receiving channel 115 configured to receive at least a portion of the second component 203. The fastener 201 is threaded into the second receiving channel 121 to fasten the first component 202 to the second component 203 (see FIGS. 2C-2D). The second receiving channel 121 has an internal thread, and the fastener 201 has an external thread which engages with the internal thread. In an embodiment, the holding clip 101 may be integrally formed by stamping. In other embodiments, the holding clip 101 may be formed by other suitable methods.

An axial length of the first collar 106 of the first clip portion 103 is set such that when the first component 202 and the second component 203 (see FIGS. 2A-2C) are connected to the holding clip assembly 100 in position, a free end 119 of the first collar 106 abuts against the second clip portion 104. In the holding clip assembly 100, the free end 119 of the first collar 106 of the first clip portion 103 is spaced apart from the second planar portion 118 of the second clip portion 104 by a short distance. When the first component 202 and the second component 203 are connected to the holding clip assembly 100 in position, the second component 203 is held by the first planar portion 107 of the first clip portion 103 and the second planar portion 118 of the second clip portion 104, and since the free end 119 of the first collar 106 abuts against the second clip portion 104, the second component 203 can be translated slightly a short distance by an external force, to ensure that the second component 203 is aligned with the first component 202. The protrusion provided on the first sealing portion 108 is received by the opening provided on the first collar 106, such that the height of the protrusion in the height direction is correspondingly set to be less than the axial length of the first collar 106.

FIG. 2A shows an assembled perspective view of the holding clip assembly 100 cooperating with the fastener 201 to connect the first component 202 to the second component 203 according to an embodiment of the present disclosure, FIG. 2B shows a right view of FIG. 2A, FIG. 2C shows a cross-sectional view along section line B-B in FIG. 2B, and FIG. 2D shows an exploded view of FIG. 2A.

As shown in FIGS. 2A-2D, the holding clip assembly 100 cooperates with the fastener 201 to fasten the first component 202 to the second component 203. In an embodiment, the fastener 201 is a screw, a threaded rod, a bolt, or the like. The first component 202 is a vehicle sheet metal. The second component 203 is a vehicle interior trim part. The second component 203 may be a doghouse structure. In other embodiments, the fastener 201, the first component 202, and the second component 203 include other suitable structures. The fastener 201 includes a head 208 and a shank 209. The first component 202 is in the form of a plate and has a through hole 207. The second component 203 includes a panel 205. The panel 205 is provided with a through hole 206. There is an opening 204 on a side of the through hole 206.

During mounting, the assembled holding clip assembly 100 is inserted into the second component 203 from a side of the second component 203 through the opening 204 such that the first collar 106 of the first clip portion 103 is located in the through hole 206 of the second component 203, and the panel 205 of the second component 203 is held by the first clip portion 103 and the second clip portion 104 of the holding clip 101. The first component 202 and/or the second component 203 is moved such that the through hole 207 of the first component 202 is aligned with the through hole 206 of the second component 203. The shank 209 of the fastener 201 then passes through the through hole 207 of the first component 202 and the third receiving channel 122 of the sealing member 102 in sequence, and the fastener 201 is securely connected to the second receiving channel 121 by, for example, screwing the fastener 201. As shown in FIG. 2C, when the fastener 201 is fastened in position, the first component 202 is clamped between the head 208 of the fastener 201 and the abutting portion 111 of the first clip portion 103 of the holding clip 101, the second component 203 is held between the first planar portion 107 of the first clip portion 103 and the second planar portion 118 of the second clip portion 104, and the free end 119 of the first collar 106 abuts against the second planar portion 118 of the second clip portion 104.

Under the effect of thermal expansion and contraction, for example, the deformation of the second component 203 is larger and the deformation of the first component 202 is smaller, the through hole 206 of the second component 203 is no longer aligned with the through hole 207 of the first component 202. Since the free end 119 of the first collar 106 abuts against the second planar portion 118 of the second clip portion 104, the second component 203 can be translated slightly a distance such that the through hole 206 of the second component 203 can be aligned with the through hole 207 of the first component 202 again.

The second sealing portion 109 of the sealing member 102 is located between the support portion 114 of the first planar portion 107 of the first clip portion 103 and the first component 202 to provide sealing between the holding clip assembly 100 and the first component 202, preventing contaminants, such as water and dust, etc., from entering the holding clip assembly 100 through a gap between the holding clip assembly 100 and the first component 202, and thus entering the second component 203. The first sealing portion 108 of the sealing member 102 is located between the first receiving channel 120 of the first clip portion 103 and the shank 209 of the fastener 201 to provide sealing between the holding clip assembly 100 and the fastener 201, preventing contaminants, such as water and dust, etc., from entering the holding clip assembly 100 through a gap between the holding clip assembly 100 and the fastener 201, and thus entering the second component 203. Therefore, the sealing member 102 of the present disclosure can effectively prevent contaminants from entering the second component 203 via the first component 202 and the fastener 201.

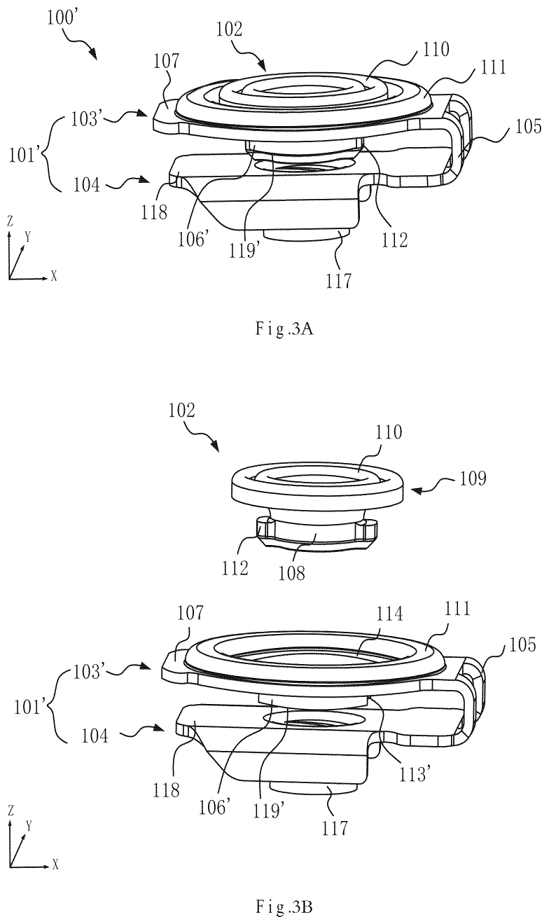

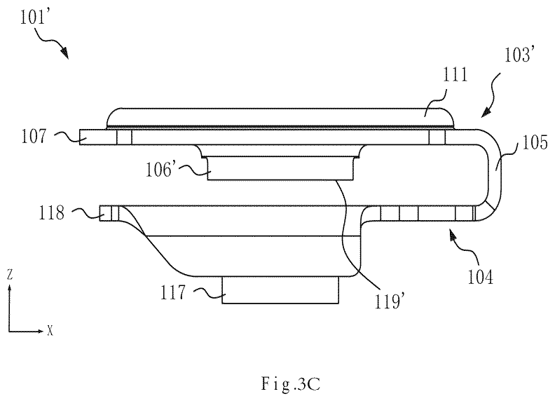

FIG. 3A shows a perspective view of the holding clip assembly 100′ according to another embodiment of the present disclosure, FIG. 3B shows an exploded view of FIG. 3A, and FIG. 3C shows a front view of the holding clip of FIG. 3A. The holding clip assembly 100′ in FIGS. 3A-3C is substantially the same as the holding clip assembly 100 in FIGS. 1A-1D, except that the axial length of the first collar 106 of the holding clip assembly 100 of FIGS. 1A-1D is different from the axial length of the first collar 106′ of the holding clip assembly 100′ of FIGS. 3A-3C.

As shown in FIGS. 3A-3C, the holding clip assembly 100′ includes a holding clip 101′ and a sealing member 102, where the holding clip 101′ includes a first clip portion 103′ and a second clip portion 104. The first clip portion 103′ includes a first planar portion 107 and a first collar 106′. The axial length of the first collar 106′ is set such that when the first component 202 and the second component 203 are connected to the holding clip assembly 100′ in position, a free end 119′ of the first collar 106′ is spaced apart from the second clip portion 104. Therefore, the second clip portion 104 can be securely clamped between the first clip portion 103′ and the second clip portion 104 without movement. In the holding clip assembly 100′, the free end 119′ of the first collar 106′ is spaced apart from the second planar portion 118 of the second clip portion 104 by a long distance, which is much greater than a short distance between the free end 119 of the first collar 106 of the first clip portion 103 and the second planar portion 118 of the second clip portion 104 in the holding clip assembly 100. The protrusion provided on the first sealing portion 108 is received by the opening provided on the first collar 106′, such that the height of the protrusion in the height direction is correspondingly set to be less than the axial length of the first collar 106. The identical structures in the holding clip assembly 100′ of FIGS. 3A-3B and the holding clip assembly 100 of FIGS. 1A-1D will not be described in detail here.

The advantageous effects achieved by the holding clip assembly of the present disclosure include at least:

In the present disclosure, the limiting structure is provided on the first clip portion of the holding clip and the limited structure is provided on the first sealing portion of the sealing member, and the limiting structure cooperates with the limited structure to limit the movement of the sealing member relative to the first clip portion, thereby limiting the movement of the sealing member relative to the holding clip. This enables the sealing member to be easily retained in the holding clip to provide stable sealing, without being limited by the materials of the both, and without affecting the original function of the holding clip assembly.

Different applications of the holding clip assembly are realized by setting the axial length of the first collar of the first clip portion of the holding clip, for example for a sliding holding clip assembly or a non-sliding holding clip assembly.

The deformable space is provided for the second sealing portion, such that the second sealing portion can easily deform to implement sealing.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. Furthermore, the technical effects and/or technical problems described in this description are exemplary rather than limiting; therefore, the disclosure in this description may be used to solve other technical problems and have other technical effects and/or may solve other technical problems. Accordingly, the examples of the embodiments of the present disclosure as set forth above are intended to be illustrative rather than limiting. Various changes may be made without departing from the spirit or scope of the present disclosure. Therefore, the present disclosure is intended to embrace all known or earlier disclosed alternatives, modifications, variations, improvements, and/or substantial equivalents.

### LIST OF REFERENCE NUMBERS

Holding Clip Assembly 100/100′
Holding Clip 101
Seal 102
First Clip Portion 103/103′
Second Clip Portion 104
Elastic Connecting Portion 105
First Collar 106/106′
First Planar Portion 107
First Sealing Portion 108
Second Sealing Portion 109
Annular Protrusion 110
Abutting Portion 111
Limited Structure 112
Limiting Structure 113/113′
Support Portion 114
Fourth Receiving Channel 115
Guiding Portion 116
Second Collar 117
Second Planar Portion 118
Free End 119/119′
First Receiving Channel 120
Second Receiving Channel 121
Third Receiving Channel 122
First Side 123/125
Second Side 124/126
Fastener 201
First Component 202
Second Component 203
Opening 204
Panel 205
Through Hole 206/207
Head 208
Shank 209

1. A holding clip assembly for connecting a first component to a second component in cooperation with a fastener, comprising:
a holding clip comprising a first clip portion and a second clip portion connected to each other, the first clip portion having a first receiving channel, and the second clip portion having a second receiving channel; and
a sealing member comprising a first sealing portion and a second sealing portion connected to each other, the first sealing portion being received in the first receiving channel and having a third receiving channel, and the second sealing portion being arranged on a top of the first clip portion away from the second clip portion,
wherein the first clip portion and the second clip portion are configured to hold at least a part of the second component between the first clip portion and the second clip portion, the first clip portion is configured to be connected at the top to the first component, and the third receiving channel and the second receiving channel are configured to receive the fastener, and
wherein the first clip portion is provided with a limiting structure, and the first sealing portion is provided with a limited structure, the limiting structure cooperate with the limited structure to limit a movement of the sealing member relative to the first clip portion.

2. The holding clip assembly according to claim 1, wherein the first clip portion comprises:
a first planar portion comprising first and second sides opposite to each other, and the top of the first clip portion is formed on the first side; and
a first collar connected to the second side of the first planar portion and forming the first receiving channel together with the first planar portion,
wherein the limiting structure is provided on the first collar.

3. The holding clip assembly according to claim 2, wherein the limiting structure comprises an opening provided on the first collar, and the limited structure comprises a protrusion provided on the first sealing portion, the protrusion is received by the opening.

4. The holding clip assembly according to claim 3, wherein the opening opens toward the second clip portion.

5. The holding clip assembly according to claim 3,
wherein the limiting structure comprises two openings arranged symmetrically with respect to a central axis of the first collar; and
wherein the limited structure comprises two protrusions arranged symmetrically with respect to a central axis of the third receiving channel.

6. The holding clip assembly according to claim 1, wherein the first sealing portion is sleeve-shaped, and the second sealing portion is flange-shaped.

7. The holding clip assembly according to claim 1, wherein the second sealing portion is provided with at least one annular protrusion on a side away from the top of the first clip portion.

8. The holding clip assembly according to claim 7, wherein the second sealing portion is provided with at least two annular protrusions radially spaced apart.

9. The holding clip assembly according to claim 1, wherein the first clip portion is provided with a protruding abutting portion on the top, the abutting portion is disposed around the second sealing portion and is configured to abut against the first component.

10. The holding clip assembly according to claim 9, wherein the abutting portion is arranged spaced apart from the second sealing portion.

11. The holding clip assembly according to claim 2, wherein the second clip portion comprises:
a second planar portion; and
a second collar connected to a side of the second planar portion away from the first clip portion and forming the second receiving channel together with the second planar portion,
wherein the second planar portion is spaced apart from the first planar portion of the first clip portion so as to receive the at least part of the second component therebetween, and
wherein the second receiving channel has an internal thread that engages with the fastener.

12. The holding clip assembly according to claim 11, wherein the first planar portion is connected to the second planar portion via an elastic connecting portion to form a generally U-shaped holding clip.

13. The holding clip assembly according to claim 2, wherein an axial length of the first collar is set such that when the first component and the second component are connected to the holding clip assembly in position, a free end of the first collar abuts against the second clip portion.

14. The holding clip assembly according to claim 2, wherein the axial length of the first collar is set such that when the first component and second component are connected to the holding clip assembly in position, a free end of the first collar is spaced apart from the second clip portion.

15. The holding clip assembly according to claim 1, wherein the holding clip is formed of a metal material, and the sealing member is formed of thermoplastic elastomer or rubber.
